(19) United States
(12) Patent Application Publication
(10) Pub. No.: US 2014/0358679 A1
(43) Pub. Date: Dec. 4, 2014

(54) METHOD OF MATCHING BETWEEN IMAGE TAGS AND ADVERTISEMENTS

(71) Applicant: Ron LEVINSON, Lapid (IL)

(72) Inventor: Ron LEVINSON, Lapid (IL)

(21) Appl. No.: 13/904,049

(22) Filed: May 29, 2013

(51) Int. Cl. G06Q 30/02

(52) U.S. Cl. CPC G06Q 30/0251
USPC 705/14.49

(57) ABSTRACT

The subject matter to discloses a method comprising receiving image tags from a computer device, wherein the image tags describe an image on a website, wherein the image tags comprise textual words; matching the image tags to a plurality of advertisements stored in a computerized memory; determining an advertisement of the plurality of advertisements that matches at least one image tag of the image tags; inserting the advertisement into an advertisement spot on the website.

### FIELD OF THE INVENTION

The subject matter relates generally to a method for matching image tags describing an image with advertisements displayed on a website.

### BACKGROUND OF THE INVENTION

Advertisement material on the world-wide-web (“WWW”) is used to promote goods and services from online retailers. Advertisements that appear on a website that is logged onto by a user are determined according to cookies stored on a user's computer and according to websites the user has visited. According to the cookies an advertisement engine may determine the interests of the user and display advertisements that the user may be inclined to pursue and observe the advertisements offers. The advertisement engine associates words from the websites the user visited with tags associated with advertisements. Some advertisement engines use words inserted by the user into a search engine, such as Google.com. The words used for searching in the search engine are used to find tags associated with advertisements that may interest the user.

### SUMMARY

It is an object of the subject matter to disclose a method comprising receiving image tags from a computer device, wherein the image tags describe an image on a website, wherein the image tags comprise textual words; matching the image tags to a plurality of advertisements stored in a computerized memory; determining an advertisement of the plurality of advertisements that matches at least one image tag of the image tags; inserting the advertisement into an advertisement spot on the website.

In some cases, the method further comprises selecting the advertisement from the plurality of advertisements.

In some cases, the method further comprises providing a score to the advertisement based on a match.

In some cases, the method further comprises generating at least some of the image tags for advertisements from the plurality of advertisements.

In some cases, the method further comprises generating the image tags from objects in the image, wherein the image tags describe the objects

In some cases, the method further comprises identifying an object in the advertisement; generating the image tags from the object, wherein the image tags describe the object in the advertisement; matching the image tags to the advertisement according to the object.

In some cases, the method further comprises identifying an object in the image; generating the image tags from the object, wherein the image tags describe the object in the image; matching the image tags to the advertisement according to the object.

In some cases, the advertisement spot is a seamless layer advertisement spot as a header of the image.

In some cases, the method further comprises receiving an advertiser's advertisement from an advertiser, wherein the advertiser's advertisement is matched to the Image; receiving an advertiser's bid to have the advertiser's advertisement advertised in the advertisement spot.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a computerized environment for matching image tags with advertisements, according to some exemplary embodiment of the subject matter;

FIG. 2 shows a method matching image tags to advertisements, according to some exemplary embodiments of the subject matter;

FIG. 3 shows display of an interface for connecting image tags to an image, according to some exemplary embodiments of the subject matter;

FIG. 4 shows a website display displaying an image with image tags and matching advertisements, according to some exemplary embodiments of the subject matter; and,

FIG. 5 shows an interface to choose a type of user that inserts an advertisement according to an image on a website, according to some exemplary embodiments of the subject matter.

### DETAILED DESCRIPTION

The subject matter discloses a method for matching image tags describing an image with advertisements displayed on a website, according to exemplary embodiments.

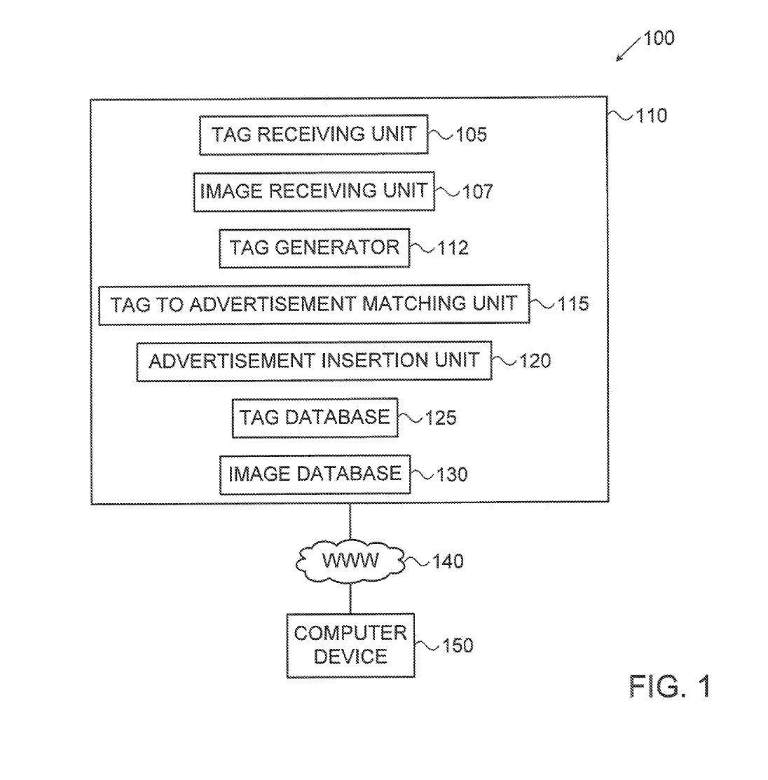

FIG. 1 shows a computerized environment for matching image tags with advertisements, according to some exemplary embodiment of the subject matter. The computerized environment 100 comprises of a server 110, which is connected to the World Wide Web (“WWW”) 140. A computer device 150 connected to the WWW 140 may access the server 110. A user of the computer device 150 inputs image tags, which comprise textual words or textual phrases that describe an image. The image tags are transmitted from the computer device 150 through the WWW 140 to the server 110. The server 110 comprises a tag receiving unit 105, which receives the image tags. The server 110 may comprise a tag generator 112, which generates the image tags describing objects located in the image. The image tags may be stored in a tag database 125, from which the tag generator 112 may obtain image tags. In some exemplary embodiments of the subject matter, the server 110 comprises an image receiving unit 107. The image receiving unit 107 may receive the image transmitted from the computer device 150 or obtained from the WWW 140, such as the server 110 receiving a hyperlink of an image location from the computer device 150. The image may be stored in an image database 130. In some cases the image is stored in the image database 130 with the image tags describing to the image.

The server 110 comprises a tag to advertisement matching unit 115, which matches the image tags with the advertisements. The tag to advertisement matching unit 115 matches at least one image tag of the image tags to an advertisement. For example, the at least one image tag is the word “ocean”. The tag to advertisement matching unit 115 matches the at least one image tag to the advertisement of a retailer of scuba diving gear, which is related to the textual word ocean, which is the image tag. In some cases, the tag to advertisement matching unit 415 provides a score to a match of the at least one image tag to the advertisement. The tag to advertisement matching unit 115 may enable the user of the computer device 150 to select the advertisement that is inserted into the website according to the score of the match.

The server 110 comprises an advertisement insertion unit 120, which inserts the advertisement obtained by the tag to advertisement matching unit 115 into the website. The advertisement inserting unit 120 may insert the advertisement into an advertisement spot on the website, for example on a right panel of the website, in some cases, the advertisement inserting unit 120 may insert the advertisement as part of the placement of the image on the website, for example as a header of the image. In some exemplary embodiments of the subject matter, the tag generator 112 may generate the image tag from the advertisement that is displayed on the website. For example, the website comprises the advertisement for scuba diving gear; the tag generator 112 may generate the tag comprising the phrase “scuba diving gear”.

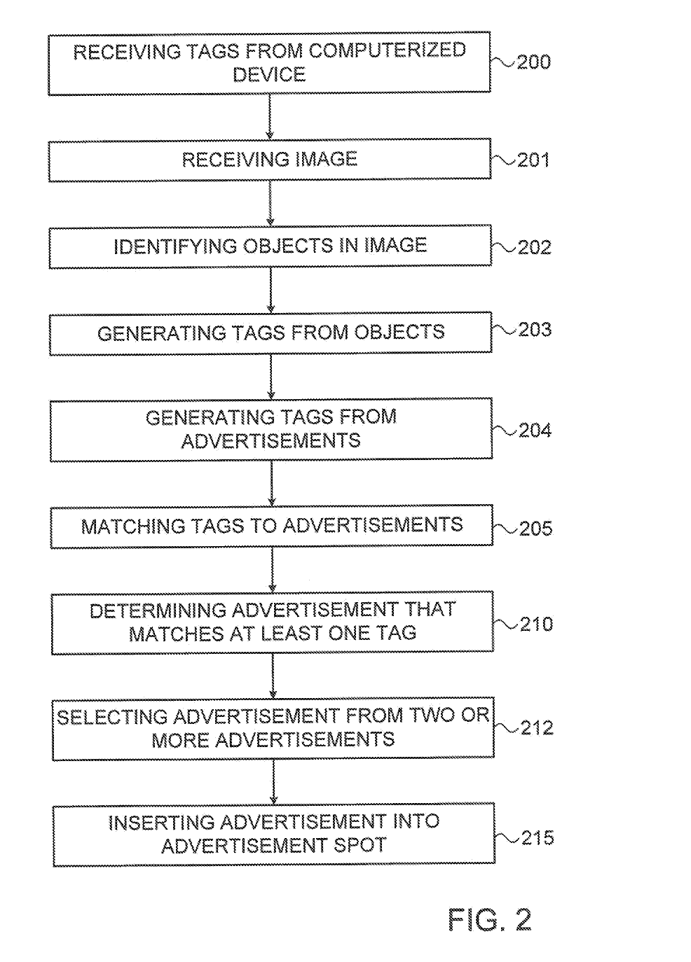

FIG. 2 shows a method for matching image tags to advertisements, according to some exemplary embodiments of the subject matter. Step 200 discloses receiving image tags from the computer device 150 of FIG. 1. The user of the computer device 150 inputs tags that describe an image. The tags are transmitted through the WWW 140 of FIG. 1 to the server 110 of FIG. 1. Step 201 discloses receiving the image. The server 110 receives the image that is displayed on a website from the computer device 150. In some cases, the server 110 receives a hyperlink address of an image location, as the website is displaying an image that is already located at another location in the WWW 140. Step 202 discloses identifying objects in the image. In some cases, the tag generator 112 of FIG. 1, identifies objects in the image. From the identified objects the tag generator 112 may generate tags. For example, the tag generator 112 identifies basketballs and basketball players in a basketball game image. Step 203 discloses generating the tags from the objects. After identifying objects in the image, the tag generator 112 generates tags that describe the objects. For example, the image is of a race car, the tag generator 112 generates tags that describe objects related to cars, such as, tires, engine oil, and the like. The server 110 may send the tags generated by the tag generator 112 to the computer device 150 to enable a user of the computer device 150 to select the tags that are most relevant. Step 204 discloses generating the image tags from advertisements. The tag generator 112 may generate tags from advertisements that are matched to other tags. Step 205 discloses matching the tags to advertisements. The tag to advertisement matching unit 115 of FIG. 1 receives the tags received by the tag receiving unit 105 and the tags generated by the tag generator 112 and searches for advertisements that are described by the tags. The tag to advertisement matching unit 115 matches advertisements according to the similarity between the tag and an advertisement's contents.

Step 210 discloses determining an advertisement that matches at least one tag of the tags. The tag to advertisement matching unit 115 may automatically select the advertisements to be inserted into the website. The advertisement may be selected by the tag to advertisement matching unit 115 according to the advertisement that matches the most tags. In some exemplary embodiments of the subject matter, the tag to advertisement matching unit 115 may generate scores to the matches made between the advertisements and to the tags. The scores may be determined according to the number of tags that match the advertisement. The scores enable the user of the computer device 150 to manually select a desired advertisement according to the match receiving the highest score. For example, the tag to advertisement matching unit 115 matches tags for the image of a cake with the advertisement of a bakery, which receives a score of 9/10 and the advertisement of a cookbook, which receives a score of 8/10. The user then selects the advertisement preferred according to the scoring of the advertisements matched by the tag to advertisement matching unit 115. Step 210 discloses selecting the advertisement from two or more advertisements. The server 110 sends the matches to the computer device 150 and the user may be able to select advertisement that the user want displayed on the website. For example the image on the website is of a cake, the user is provided an option to select a bakery advertisement or a cookbook advertisement. Step 215 discloses inserting the advertisement into an advertisement spot. The advertisement insertion unit 120 inserts the advertisement into an advertisement spot. In some cases, the advertisement spot is located as a lay seamless on the image, where the advertisement is imbedded as part of the image, for example, above the image. For example, the image is a photograph of a basketball team, and the advertisement inserted is for a basketball team's fan club. The advertisement appears as a header of the photograph of the basketball team.

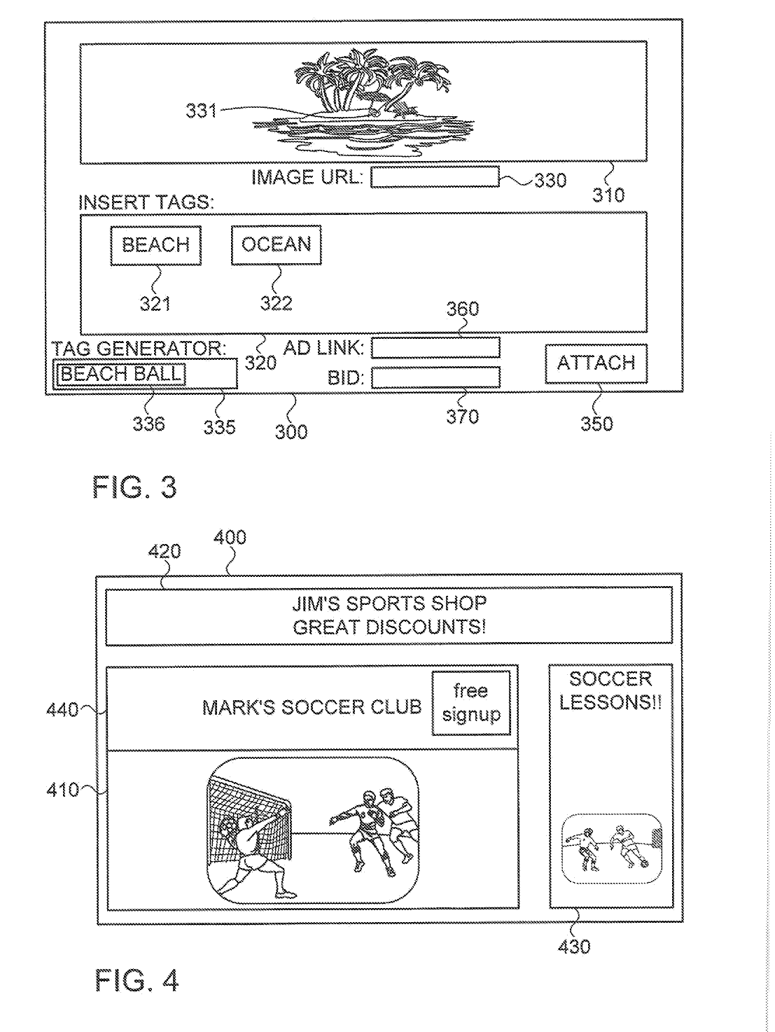

FIG. 3 shows display of an interface for connecting tags to an image, according to some exemplary embodiments of the subject matter. The interface 300 comprises an image 310 to which the tags are connected. In some exemplary embodiments of the subject matter, the interface 300 may comprise of a space for inserting an image hyperlink 330 to a WWW location in the WWW 140 of image 1. For example, the user inserts the hyperlink of the picture as www.imagestorage.com/image1234. The interface 300 comprises a tag box 320, into which tags are inserted. The tags inserted into the tag box 320 comprise textual words or phrases, for example “beach” 321 or “ocean” 322. In some exemplary embodiments of the subject matter the interface 300 may comprise a tag generator box 335, which displays tags that the server 110 of FIG. 1 generates from objects in the image 310, The tag generator 112 of FIG. 1 detects objects in the image 310, for example an object in the image is a beach ball 331 and generates a beach ball tag 336 and displays the beach ball tag 336 in the tag generator box 335. In some exemplary embodiments of the subject matter, the interface 300 enables adding an advertisement in an add link 360. For example, the user knows of an online beach supply store. The user enters the hyperlink to the online beach supply store into the add link 360, to match the advertisement to the image 310. In some cases, user that is an advertiser may insert an advertiser's bid to insert an advertiser's advertisement into the advertisement spot by entering a bid sum into a bid box 370. For example, the advertiser is a retailer of bathing suits and the advertiser wants the advertisement to display an advertiser's retail shop information. The retailer inputs the advertisement link into the add link 360, such as www.bathingsuitsdiscount.com/advertisement2. The advertiser then inputs the advertiser's bid, such as 200 dollars to have the advertisement displayed. The advertisement may be inserted into an advertisement spot where the advertiser's bid is higher than advertisement bids of other advertisers.

In some exemplary embodiments of the subject matter, the user may choose to look for images that match tags describing an advertisement. The user inputs an advertisement into to the add link 360 and inserts tags describing the advertisement into the tag box 320. The tag generator 112 generates tau for the advertisements according to objects in the advertisement and displays the tags in the tag generator box 335. The server 110 locates images that match the tags describing the advertisement and inserts the images into the website. For example, the user inserting a cosmetics brand advertisement into the website. The tags of the cosmetics brand advertisement are matched to images of people using a cosmetic from a cosmetic brand featured in the cosmetics brand advertisement. The server 110 inserts the matched images into the website with the cosmetics brand advertisement.

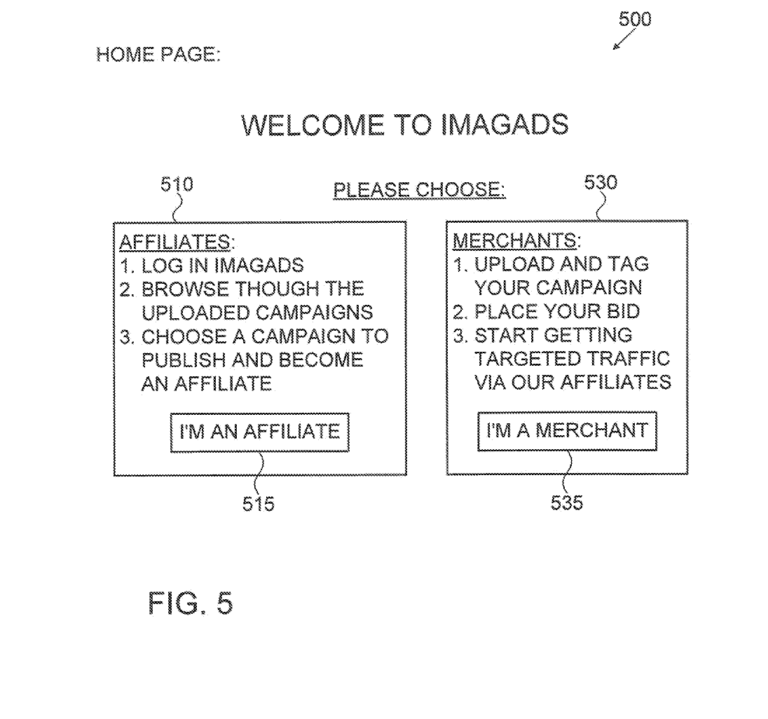

FIG. 4 shows a website display displaying an image with tags and matching advertisements, according to some exemplary embodiments of the subject matter. The website display 400 shows an image 410 with the advertisement inserted into a header advertisement spot 420, where the advertisement spot is located at the top of the website display. The advertisement is displayed at the top of the website. The advertisement may be inserted into a right advertisement spot 430, where the advertisement is displayed on the right side of the website. In some cases the advertisement is inserted into a seamless lay advertisement spot 440, which is attached to the image. For example, the advertisement appears as a header of the image. In some exemplary embodiments of the subject matter, the advertisement may be embedded onto the image 410. The advertisement is hidden and is displayed upon detection of a mouse hover over the image 410, FIG. 5 shows an interface to choose a type of user that inserts an advertisement according to an image on a website, according to some exemplary embodiments of the subject matter. The interface 500 comprises an affiliate display 510, which is a window through which an affiliate of a website may enter and match tags with advertisements. The affiliate display 510 may comprise an affiliate icon 515, which enables accessing an interface for connecting tags to an image, such as that of FIG. 3. In some exemplary embodiments of the subject matter, the user is an advertiser, who wants to have an advertisement displayed on the website. The interface 500 comprises a merchant display 530 to enable the advertiser to match advertisements to images. The merchant display 530 comprises a merchant icon 535, which enables the merchant to access the interface for connecting tags to an image, such as that of FIG. 3. The advertiser may attach an advertiser's advertisement to the image on the website. The advertiser then may bid to have the advertiser's advertisement displayed on the website or as a lay seamless on the image,

While the disclosure has been described with reference to exemplary embodiments, it will be understood by those skilled in the art that various changes may be made and equivalents may he substituted for elements thereof without departing from the scope of the subject matter. in addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

1. A method, comprising:
receiving image tags from a computer device, wherein the image tags describe an image on a website, wherein the image tags comprise textual words;
matching the image tags to a plurality of advertisements stored in a computerized memory;
determining an advertisement of the plurality of advertisements that matches at least one image tag of the image tags;
inserting the advertisement into an advertisement spot on the website.

2. The method of claim 1, further comprises, selecting the advertisement from the plurality of advertisements.

3. The method of claim 1, further comprises providing a score to the advertisement based on a match.

4. The method of claim 1, further comprises generating at least some of the image tags for advertisements from the plurality of advertisements.

5. The method of claim 1, further comprises generating the image tags from objects in the image, wherein the image tags describe the objects.

6. The method of claim 1, further comprises:
identifying an object in the advertisement;
generating the image tags from the object, wherein the image tags describe the object in the advertisement;
matching the image tags to the advertisement according to the object.

7. The method of claim 1, further comprises:
identifying an object in the image;
generating the image tags from the object, wherein the image tags describe the object in the image;
matching the image tags to the advertisement according to the object.

8. The method of claim 1, wherein the advertisement spot is a seamless layer advertisement spot as a header of the image.

9. The method of claim 1, further comprises:
receiving an advertiser's advertisement from an advertiser, wherein, the advertiser's advertisement is matched to the image;
receiving an advertiser's bid to have the advertisers advertisement advertised in the advertisement spot.
